(19) United States
(12) Patent Application Publication
(10) Pub. No.: US 2021/0352270 A1
(43) Pub. Date: Nov. 11, 2021

(54) Method and System for Accurate Measurement of Color Performance of Electronic Displays Using Low-Accuracy Measurement Devices

(71) Applicant: Zenith Electronics LLC, Lincolnshire, IL (US)

(72) Inventors: Benjamin L. Bodner, Santa Clara, CA (US); Neil T. Robinson, Santa Clara, CA (US)

(73) Assignee: Zenith Electronics LLC, Lincolnshire, IL (US)

(21) Appl. No.: 17/313,650

(22) Filed: May 6, 2021

Related U.S. Application Data
(60) Provisional application No. 63/021,417, filed on May 7, 2020.

(51) Int. Cl. H04N 17/02; G01J 3/50; H04N 9/64; G01J 3/28

(52) U.S. Cl. CPC H04N 17/02; G01J 3/2823; H04N 9/64; G01J 3/506

(57) ABSTRACT

In a calibration method, high-accuracy reference values obtained using a high-accuracy optical sensor are received, low-accuracy reference values are determined from reference colors captured from a display using a low-accuracy optical sensor having a lower accuracy than the high-accuracy optical sensor, color measurement values are determined from one or more colors captured from the display using the low-accuracy optical sensor, and the color measurements values are adjusted based on one or more color conversion equations to obtain adjusted color measurement values. The one or more color conversion equations are based on the high-accuracy measurement values and the low-accuracy measurement values. The high-accuracy reference values are reused for calibrations of one or more other low-accuracy optical sensors.

### CROSS REFERENCE TO RELATED APPLICATIONS

This patent application claims priority to, and the benefit of, U.S. Provisional Patent Application No. 63/021,417, filed May 7, 2020, which is incorporated herein by reference in its entirety.

### BACKGROUND

### Field

The present disclosure relates to a method that produces accurate color measurements of electronic displays using color measurement devices that have limited accuracy.

More particularly, this disclosure relates to a method of pre-recording and storing a set of color measurements from an individual display made with a high-accuracy color measurement device and then later using those high-accuracy measurements to correct any other measurement of that individual display made with any lower-accuracy measurement device.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 is a calibration environment according to exemplary embodiments.

FIG. 2A illustrates a low-accuracy optical sensing device according to an exemplary embodiment.

FIG. 2B illustrates the low-accuracy optical sensing system according to an exemplary embodiment.

FIG. 3A illustrates a high-accuracy optical sensing device according to an exemplary embodiment.

FIG. 3B illustrates the high-accuracy optical sensing system according to an exemplary embodiment.

FIG. 4 illustrates a calibration server according to an exemplary embodiment.

FIG. 5 illustrates an electronic display according to an exemplary embodiment.

FIG. 6A is a flowchart of a calibration method according to an exemplary embodiment.

FIG. 6B shows an illustrative workflow of the calibration method of FIG. 6A.

FIG. 7 is a flowchart of a calibration method according to an exemplary embodiment.

FIG. 8 is a flowchart of a calibration method according to an exemplary embodiment.

FIG. 9 is an example computer system according to exemplary embodiments.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The color of light is measured and expressed using three values, called tristimulus values (XYZ), which can be converted into other color values such as luminance and chromaticity (Yxy), opponent color coordinates (L*a*b*), polar color coordinates (hue, saturation, lightness), or primary color drive values (RGB).

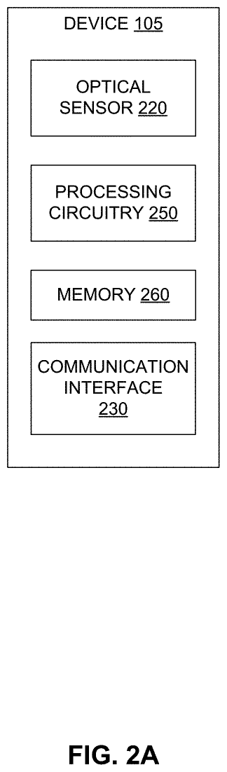

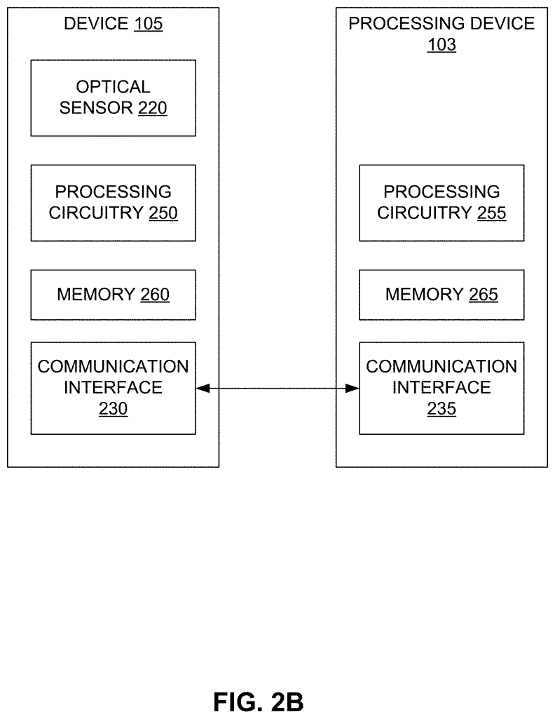

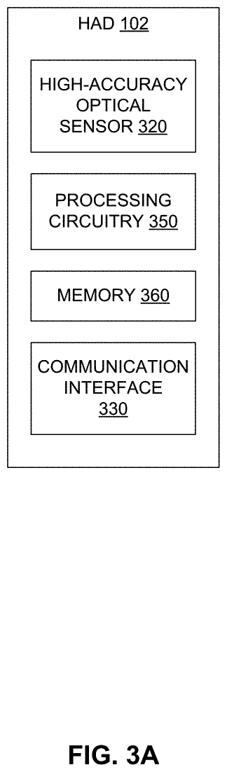

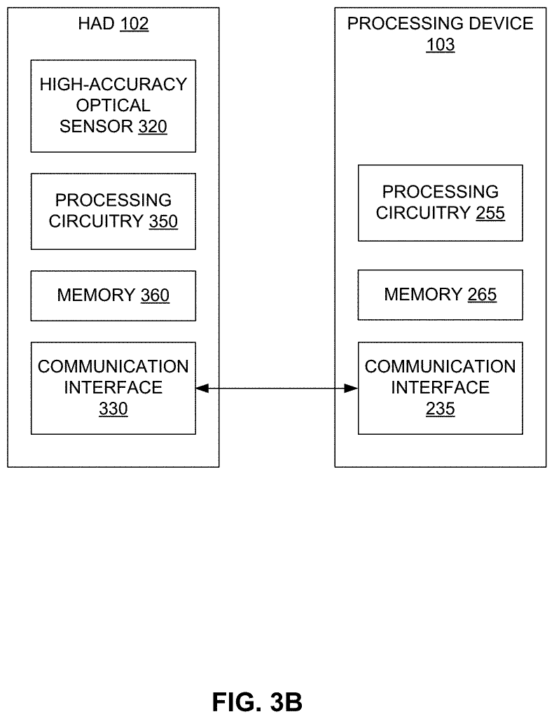

Certain color measurement devices, including but not limited to spectro-radiometers, are able to record color very accurately. These devices are referred to as high-accuracy devices. Examples of high-accuracy devices (HAD) 102 are illustrated in FIGS. 3A-3B. Other color measurement devices, including but not limited to most colorimeters and RGB cameras (e.g. cameras of mobile devices), have accuracy limitations that result in measurement error. These devices are referred to as low-accuracy devices 105, examples of which are illustrated in FIGS. 2A-2B. Devices with lower accuracy may be preferred over high-accuracy devices for a variety of reasons including lower cost, higher speed, user availability, and smaller size.

When measuring an electronic display 110 with a low-accuracy device 105, measurement error can be corrected by calibrating the low-accuracy measurement device 105 against a high-accuracy measurement device 102. This calibration may involve taking measurements of three or more different colors on the display with both the low and high accuracy devices. A set of equations is computed from these measurements made by the two devices. This set of equations, typically represented as a matrix multiplication, can be used to correct measurements made with the low-accuracy device of any color produced by the display.

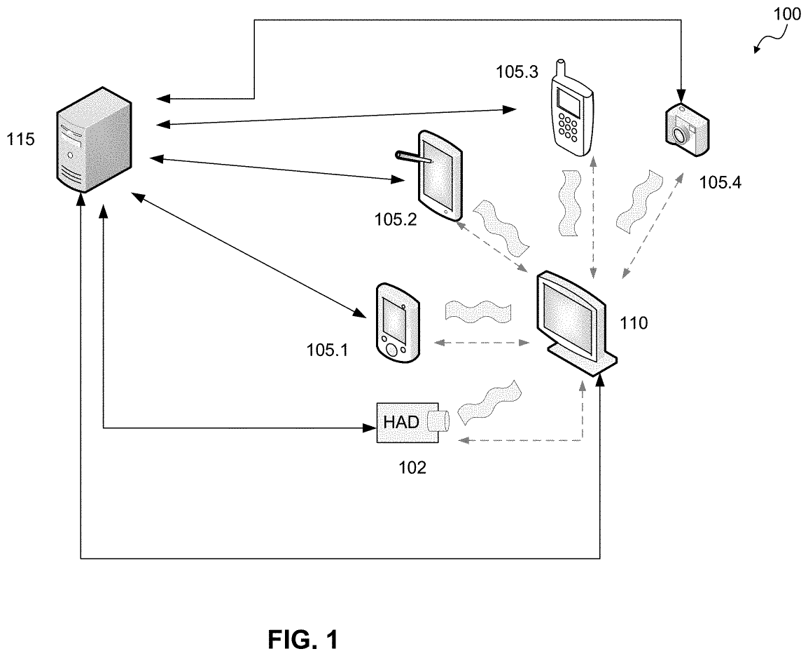

An example of a calibration system 100 is illustrated in FIG. 1. In an exemplary embodiment, the system 100 includes one or more low-accuracy devices (LAD) 105 and a high-accuracy devices (HAD) 102 that interact with a display 110 to perform one or more respective measurements of the display 110. The LAD 105 and/or the HAD 102 may be configured to communicate (wirelessly, using WiFi, Bluetooth, 3G, 4G, 5G, etc., and/or via a wired connection) with the display 110. Alternatively or additionally, the LAD 105, the HAD 102, and/or display 110 may be configured to communicate (wirelessly and/or via a wired connection) with server or database 115. The database 115 is configured to store data and/or information, including, for example, high-accuracy measurement data, low-accuracy measurement data, one or more calibration equations, identification information of the LAD 105, the HAD 102, and/or display 110, and/or other information and/or data as would be understood by one of ordinary skill in the art.

In an exemplary embodiment, the LAD 105 includes: an optical sensor 220 configured to measure the color of light; memory 260 that stores information and/or data, such as measurement data, program code, and/or other information; a communication interface 230 that may include one or more input and/or output interfaces (e.g. speakers, microphone, input/output ports) and/or one or more wired and/or wireless transceivers configured for wired and/or wireless communications, and processing circuitry 250 that is configured to control the operation of the LAD 105, including controlling the LAD 105 to perform one or more measurements using the optical sensor 220. Examples of the LAD 105 may include a mobile communication device with an optical sensor (e.g. smartphone, tablet, etc.), colorimeter, a Red-Green-Blue (RGB) digital camera, such as a digital single-lens reflex (DSLR) camera, or another low-accuracy optical sensing device as would be understood by one of ordinary skill in the art.

As illustrated in FIG. 2B, the LAD 105 may communicate with a processing device 103, where the processing device 103 may perform one or one processing operations alone or in combination with processing performed by the LAD 105. That is, the LAD 105 may partially or fully offload processing to the processing device 103.

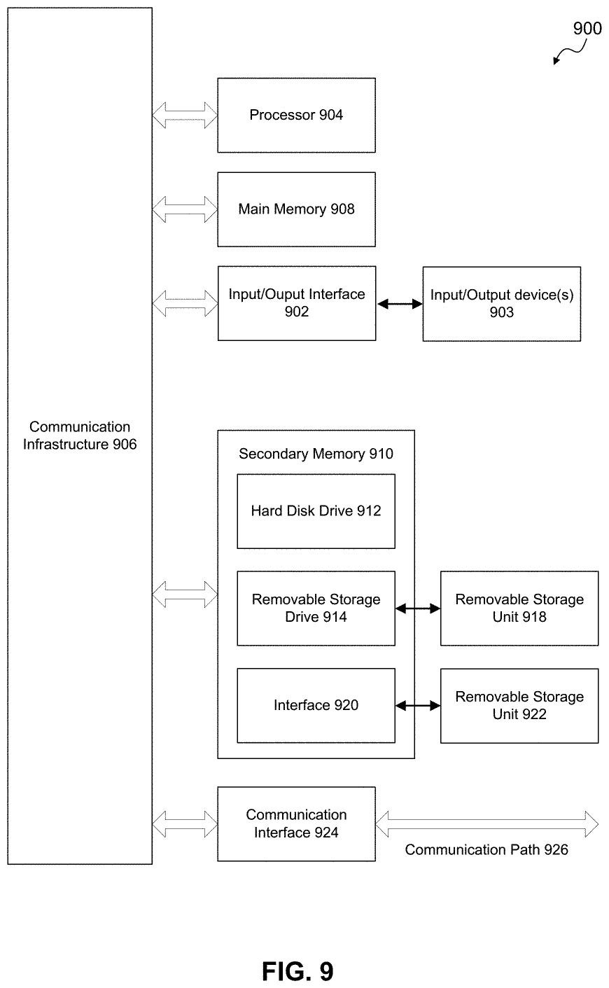

The processing device 103 may include a communication interface 235 that establishes communication with the communication interface 230 of the LAD 105; a memory 265 that stores information and/or data, such as measurement data, program code, and/or other information; and processing circuitry 255 that is configured to control the operation of the processing device 103, including controlling the device 103 to perform one or more data and/or image processing operations. In one or more aspects, the processing circuitry 255 may be configured to control the operation of the LAD 105. The communication interface 235 may include one or more input and/or output interfaces (e.g. speakers, microphone, and input/output ports) and/or one or more wired and/or wireless transceivers configured for wired and/or wireless communications. In an exemplary embodiment, the processing device 103 is a computer, such as the computer illustrated in FIG. 9.

FIGS. 3A and 3B illustrate HADs 102 according to exemplary embodiments. The HAD 102 includes: a high-accuracy optical sensor 320 configured to measure the color of light with an increased accuracy as comparted to the sensor 220 of the LAD 105; memory 260 that stores information and/or data, such as measurement data, program code, and/or other information; a communication interface 230 that may include one or more input and/or output interfaces (e.g. speakers, microphone, display screens, input/output ports) and/or one or more wired and/or wireless transceivers configured for wired and/or wireless communications, and processing circuitry 350 that is configured to control the operation of the HAD 102, including controlling the HAD 102 to perform one or more measurements using the optical sensor 320. The HAD 102 may be a spectro-radiometer, but is not limited thereto.

As illustrated in FIG. 3B, the HAD 102 may communicate with a processing device 103, where the processing device 103 may perform one or one processing operations alone or in combination with processing performed by the HAD 102. That is, the HAD 102 may partially or fully offload processing to the processing device 103.

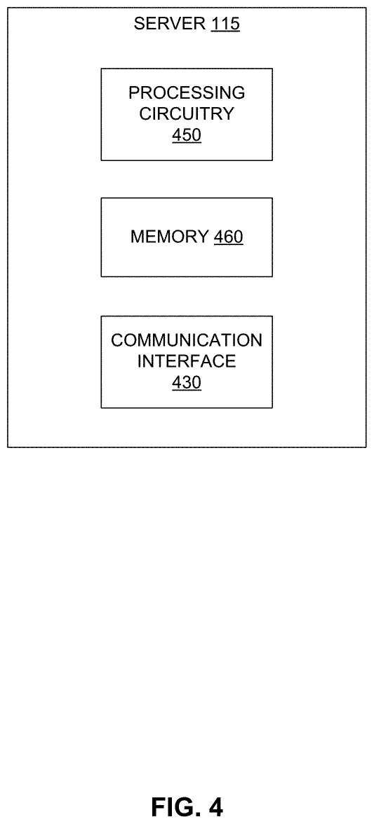

FIG. 4 illustrates a server or database 115 according to an exemplary embodiment. The server 115 may include: a communication interface 430 that may communicate one or more other devices, such as the LAD 105, HAD 102, display 110, or other devices as would be understood by one of ordinary skill in the art; a memory 460 that may store high-accuracy measurement data, low-accuracy measurement data, one or more calibration equations, identification information of the LAD 105, HAD 102, and/or display 110, and/or other information, program code, and/or data as would be understood by one of ordinary skill in the art; and processing circuitry 450 that is configured to control the operation of the server 115. The communication interface 430 may include one or more input and/or output interfaces (e.g. speakers, microphone, display screens, input/output ports) and/or one or more wired (e.g. Ethernet) and/or wireless transceivers configured for wired (e.g. Ethernet) and/or wireless (e.g. WiFi, Bluetooth, 3G, 4G, 5G, etc.) communications. In an exemplary embodiment, the server 115 is a computer, such as the computer illustrated in FIG. 9.

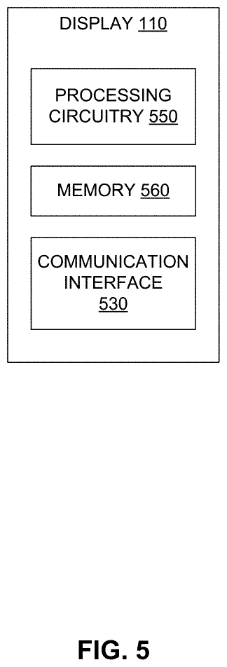

FIG. 5 illustrates a display 110 according to an exemplary embodiment. The display 110 may include: a communication interface 530 that may communicate one or more other devices, such as the LAD 105, HAD 102, server 115, or other devices as would be understood by one of ordinary skill in the art; a memory 560 that may store high-accuracy measurement data, low-accuracy measurement data, one or more calibration equations, identification information of the LAD 105, HAD 102, and/or display 110, and/or other information, program code, and/or data as would be understood by one of ordinary skill in the art; and processing circuitry 550 that is configured to control the operation of the display 110. The communication interface 530 may include one or more input and/or output interfaces (e.g. speakers, microphone, display screens, input/output ports) and/or one or more wired (e.g. Ethernet) and/or wireless transceivers configured for wired (e.g. Ethernet) and/or wireless (e.g. WiFi, Bluetooth, 3G, 4G, 5G, etc.) communications. In an exemplary embodiment, the display 110 is a television, smart television, computer monitor, or other display as would be understood by one of ordinary skill in the relevant arts.

When users of low-accuracy measurement devices do not have access to a high-accuracy device, they must rely on calibration equations that either are preloaded on their device, are provided by calibration software, or are publicly available. Such calibration equations are generalized for broad categories of displays and measurement devices, and may not account for variations in spectral light emission between individual displays or variations in spectral sensitivity between individual measurement devices. To correct the display color measurements made with a low-accuracy device, an independent calibration is required for each individual pair of device and display.

Calibration of a low-accuracy color measurement device to match and accurately measure an individual display can be achieved by first pre-recording high-accuracy measurements of reference colors (e.g. three or more reference colors), where the measurements are made available in that specific display; stored in a remote memory storage device (e.g. server/database 115) and made accessible to the display and/or the low-accuracy color measurement device; and/or in a storage location where information specific to that display is stored. These pre-recorded measurements can then be used to compute correction or calibration equations for the low-accuracy color measurement device.

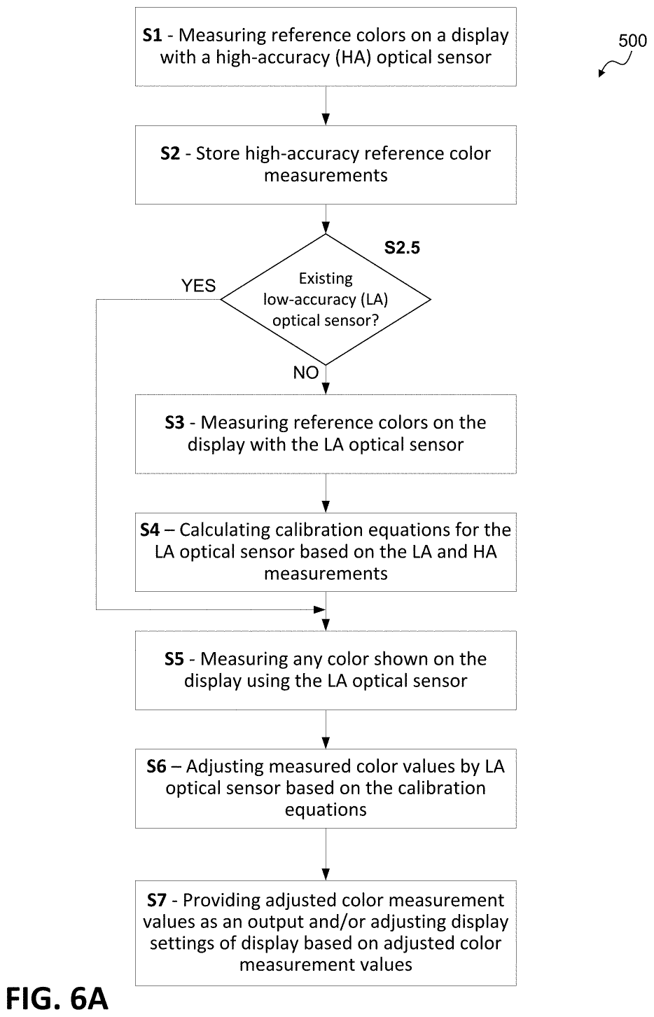

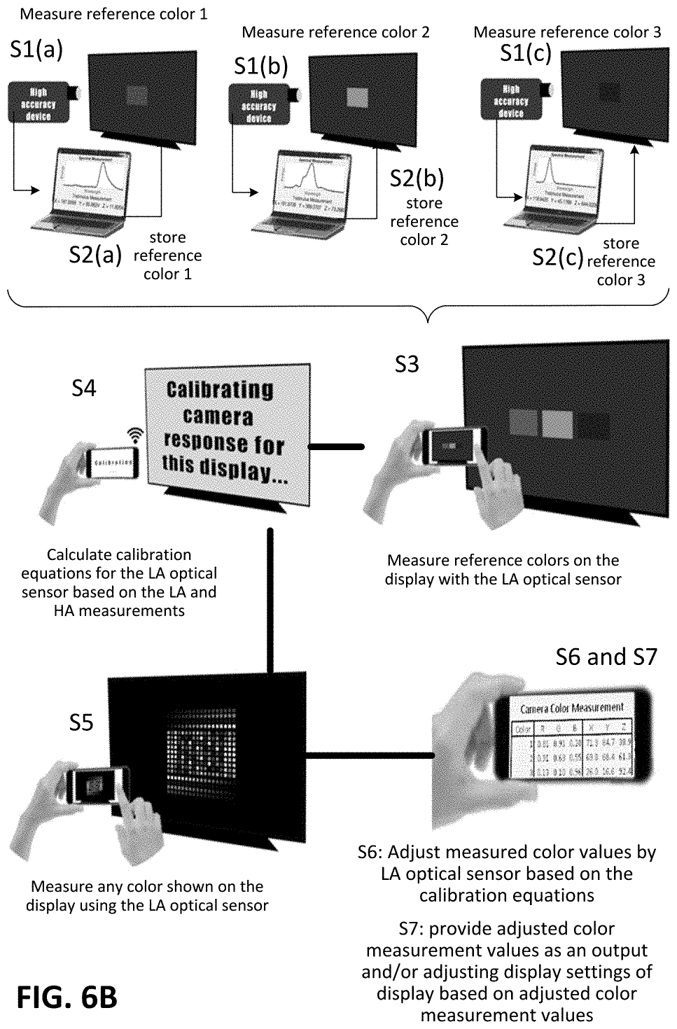

FIG. 6A illustrates a calibration method according to an exemplary embodiment. The method will also be described with reference to FIG. 6B, which shows an illustrative workflow of the method. Two or more of the operations may be performed simultaneously. Further, the operations may be performed in different orders than illustrated. The illustrations in the workflow of FIG. 6B show an exemplary application of the method illustrated in the flow chart of FIG. 6A, and the illustrations in FIG. 6B are labeled (S1) through (S7) to correspond with the operations S1-S7 in FIG. 6A. Although FIG. 6B shows a mobile device as the low-accuracy device, the workflow is applicable to any low-accuracy devices.

In an exemplary embodiment, the method includes measuring a set of reference colors (S1) to obtain tristimulus values (XYZ). In an exemplary embodiment, the reference colors are the independent color elements of the display (red, green, and blue in most displays), but may involve additional reference colors or different reference colors. In this example, the color measurements are performed using a high-accuracy measurement device (e.g. high-accuracy optical sensor), such as a spectro-radiometer or other high-accuracy optical sensor as would be understood by one of ordinary skill in the art, which is configured to record color with high accuracy. These high-accuracy measurements (e.g. tristimulus values (XYZ)), are then stored (S2) in the display hardware and/or in a database. These measurements can be referred to as high-accuracy measurements because they have a higher accuracy than the measurements obtained in operation S3, which are referred to as low-accuracy measurements. The high-accuracy measurements for the particular display can be reused for subsequent calibrations for the display 110 with various different low-accuracy devices 105.

To calibrate a low-accuracy color measurement device (LAD 105), the method obtains measurements with the low-accuracy device (e.g. low-accuracy optical sensor) of the reference colors on the display (S3). The low-accuracy device can include a colorimeter, a Red-Green-Blue (RGB) digital camera, such as a DSLR camera or a mobile-phone camera, or another low-accuracy optical sensor as would be understood by one of ordinary skill in the art.

The low-accuracy device (LAD) 105 can then communicate with the display 110 (and/or a storage location/database 115 where that display-specific information is stored) to retrieve the previously-obtained high-accuracy measurements that were recorded earlier (in S1 and S2). In this example, the operations S1 and S2 can be performed, by for example, the display manufacturer, or a third-party calibration company. The low-accuracy device can then perform the calculation of the calibration equations (S4) as described below.

In another exemplary embodiment, the low-accuracy device can provide the low-accuracy measurements to the display 110 and/or reference color database/server 115, and the display 110 and/or database/server 115 can be configured to perform the calculation of the calibration equations. In an exemplary embodiment, the communications of the low-accuracy measurements and the high-accuracy measurements can be exchanged between the respective devices 102, 105, 110, 115. In this example, the low-accuracy device 105 and the display 110 (and/or database/server 115) can cooperatively perform the calculation of the calibration equations. In an exemplary embodiment, the low-accuracy measurements and the high-accuracy measurements are provided to a remote processing device (e.g. cloud-based system, server, database 115), and the calculation of the calibration equations is performed by the remote processing device and provided to the low-accuracy device. That is, the processing and calculation of the calibration equations can be performed by one or more of the devices individually, or two or more of the devices can cooperatively perform the processing and calculations.

As discussed above, the measurements of the reference colors made by the two devices (high and low accuracy devices) are then used to produce a set of calibration equations (S4) that can correct subsequent measurements made by that particular low-accuracy device 102 for that particular display 110. The method of producing this series of equations depends on the number and type of color elements used by the display. For example, one method for displays with three independent color elements (typically red, green, and blue) produces a set of three equations implemented as a matrix multiplication. See, ASTM, “E 1455-17, Standard Practice for Obtaining Colorimetric Data from a Visual Display Unit Using Tristimulus Colorimeters,” 2017.

In aspects where the low-accuracy device has previously been used for the display (S2.5), the method can transition from S2 directly to S5, and the operations at S3 and S4 may be omitted.

In an exemplary embodiment of the disclosure when the high-accuracy measurements and the low-accuracy measurements both include tristimulus values (XYZ), such as when the low-accuracy device is, for example, a colorimeter, the following equations 1-3 can be implemented as a matrix-inverse and matrix multiplication:

$$\begin{matrix}D = [ \begin{matrix}{X}_{r} & {Y}_{r} & {Z}_{r} \\ {X}_{g} & {Y}_{g} & {Z}_{g} \\ {X}_{b} & {Y}_{b} & {Z}_{b}\end{matrix} ] , T = [ {X}_{T} {Y}_{T} {Z}_{T} ] & Eq . 1 \\ M = {D}_{L}^{- 1} * {D}_{H} & Eq . 2 \\ {T}_{H} = {T}_{L} * M & Eq . 3\end{matrix}$$

In this embodiment, D is a matrix that contains tristimulus measurements (XYZ) of three reference colors (red, green, blue), T contains tristimulus measurements of any measured color, L denotes measurement by the low-accuracy device, H denotes measurement by the high-accuracy device, and M contains three sets of coefficients that, when multiplied by the low-accuracy tristimulus measurements, will reduce error from the high-accuracy measurements.

In one or more exemplary embodiments of the disclosure, the low-accuracy color measurement device is configured to obtain XYZ tristimulus color measurements. In this example, the low-accuracy device can be a colorimeter, but is not limited thereto. Colorimeters are intended to directly capture XYZ tristimulus color measurements by using a combination of optical filters and sensors to produce spectral sensitivities that match standardized XYZ spectral response functions. However, most colorimeters have variations between their actual spectral sensitivities and the standardized XYZ functions, leading to error. This error can be corrected for a specific light source by using measurements taken of the light source with the colorimeter (S5) and a device with higher accuracy (S1). In operation S5, the colorimeter (or other low-accuracy device configured to obtain XYZ tristimulus color measurements) measures one or more colors shown on the display.

For a display that uses three color elements, a correction (S6) can be applied to the measurements obtained in operation S5 using the equations 1-3.

In operation S7, the adjusted color measurement values can be provided as an output of the low-accuracy device 105, such as being displayed on a display of the low-accuracy device 105, and/or be communicated to the display 110 being measured and/or to one or more other devices (e.g. server/database 115). In an exemplary embodiment, the adjusted color measurement values can be provided to the display 110 being measured and the settings of the display 110 can be automatically adjusted based on the adjusted color measurement values. In this example, the low-accuracy device 105 may be configured to control the display 110 to adjust its settings based on the adjusted color measurement values.

For displays with more than three color elements, more complex methodology using additional reference colors may be used. In an exemplary embodiment, low accuracy measurements of certain displays that have a fourth color element can be corrected using a method and system as described in Bodner, et al. “Calibration of Colorimeters for RGBW Displays,” SID Symposium Digest of Technical Papers, 50, 1206-1209, which is incorporated herein by reference in its entirety. In an exemplary embodiment, this method includes measurement of four reference colors (red, green, blue, and white) and additional steps used to calculate multiple sets of correction equations and to determine which set of equations to apply to each low-accuracy measurement.

In another exemplary embodiment of the disclosure, the low-accuracy color measurement device is configured to obtain RGB measurements. In this example, the low-accuracy device can be, for example, a RGB digital camera, such as a DSLR camera or a mobile-phone camera, or another RGB optical sensor as would be understood by one of ordinary skill in the art. While these devices capture red, green, and blue color measurements, a generalized color transformation is often created for a given model of camera. In this embodiment, the calculation of the calibration equations in operation S4 may include a RGB-to-XYZ transformation. This generalized transform is used to convert from the low-accuracy device's raw RGB color space to XYZ tristimulus space, which can allow for the images and/or videos to be electronically displayed or printed with consistent color reproduction. This transformation will include some color error, with the amount of error depending on the similarity between colors being sensed (e.g. photographed) and colors used to create the generalized RGB-to-XYZ transformation. This error can be significantly reduced for measurements (e.g. photographs) of a specific display by creating a unique color transform for that display and low-accuracy device (e.g. RGB camera). Creation of this specified color transform may be similar to the equations 1-3 for displays with three color elements, and use the following Equations 4-6 below in operation S4:

$$\begin{matrix}D = [ \begin{matrix}{X}_{r} & {Y}_{r} & {Z}_{r} \\ {X}_{g} & {Y}_{g} & {Z}_{g} \\ {X}_{b} & {Y}_{b} & {Z}_{b}\end{matrix} ] , T = [ {X}_{T} {Y}_{T} {Z}_{T} ] , \\ E = [ \begin{matrix}{R}_{r} & {G}_{r} & {B}_{r} \\ {R}_{g} & {G}_{g} & {B}_{g} \\ {R}_{b} & {G}_{b} & {B}_{b}\end{matrix} ] , S = [ {R}_{T} {G}_{T} {B}_{T} ] & Eq . 4 \\ M = {E}^{- 1} * {D}_{H} & Eq . 5 \\ {T}_{H} = S * M & Eq . 6\end{matrix}$$

In this embodiment, D is a matrix that contains tristimulus measurements (XYZ) of three reference colors (red, green, blue) and E is a matrix that contains camera-raw measurements (RGB) of the same reference colors. T contains tristimulus values for any color and S contains camera-raw measurements of the same color. H denotes measurement by the high-accuracy device and M contains three sets of coefficients that, when multiplied by the camera-raw measurements, will produce tristimulus values. Upper-case R, G, and B represent camera-raw signals, while lower-case r, g, and b represent red, green, and blue reference colors shown on the display. The illustrations in the workflow of FIG. 6B show an exemplary application of the method illustrated in the flow chart of FIG. 6A. The illustrations in FIG. 6B are labeled (S1) through (S7), with the corresponding operations S1-S7 in FIG. 6A.

Unlike conventional methods where pre-recorded accurate color measurements from various displays are used to calibrate a specific low accuracy measurement device to make accurate measurements from many displays, the method according to exemplary embodiments provide a process for correcting any low accuracy measurement device so as to make accurate measurements from a specific display. In these inventive processes, the high-accuracy measurements for the particular display are reused for subsequent calibrations for the display 110 with various different low-accuracy devices 105.

The light output of a display typically varies depending on the angle from which the display is viewed. In one embodiment, the high-accuracy measurement device would record measurements of the reference colors at multiple viewing angles. A correction for a low-accuracy device would be computed based on its specific viewing angle, using interpolated values if its specific viewing angle was not used with the high-accuracy measurement device.

The light output of a display may vary depending on the amount of time the display has been used, especially the amplitude of the light output (luminance). In one embodiment of the disclosure, the high-accuracy measurement device would record multiple measurements of a sample display over an extended period of time to characterize any temporal luminance or color shift. When a correction for a low-accuracy device is computed for a specific display, the high-accuracy reference color measurements for that specific display would be adjusted using the temporal characterization of the sample display based on the number of hours the specific display had been active.

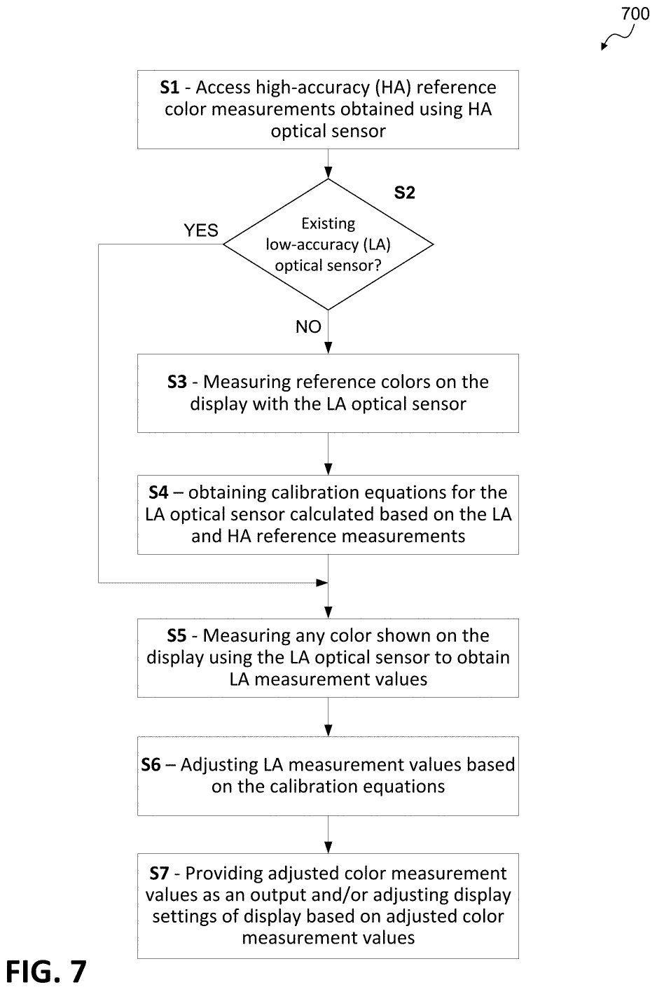

FIG. 7 illustrates a calibration method according to an exemplary embodiment. Two or more of the operations may be performed simultaneously. Further, the operations may be performed in different orders than illustrated. In operation S1, high-accuracy (HA) reference color measurements are accessed. For example, the LAD 105 may communicate with the server 115, display 110, or other external device to access or otherwise obtain the previously-obtained and stored high-accuracy reference color measurements. These high-accuracy reference color measurements have been previously obtained by a HAD 102 and stored for later access.

At operation S2, it is determined if the LAD 105 has previously been used in a calibration process for the display 110 that resulted in calibration equations having been generated for the display 110 and particular LAD 105. If so, the flowchart transition from S1 directly to S5, and the operations at S3 and S4 may be omitted.

At operation S3, reference colors displayed on the display 110 are measured by the LAD 105 to obtain low-accuracy (LA) reference color measurements.

At operation S4, one or more calibration equations are obtained for the LAD 105 based on the LA reference color measurements and the HA reference color measurements. For example, the LAD 105 can calculate the calibration equation(s) based on the LA reference color measurements and the HA reference color measurements. In other aspects, the LAD 105 can offload (e.g. partially or fully) the calculation to the display 110 and/or server 115. In these aspects, the LAD 105 can provide the LA reference color measurements and the HA reference color measurements to the external device(s). In other aspects, the external device(s) can also access the HA reference color measurements separately and receive only the LA reference color measurements from the LAD 105. For example, the LAD 105 can provide the low-accuracy measurements to the display 110 and/or server 115, and the display 110 and/or server 115 can be configured to perform the calculation of the calibration equations. In an exemplary embodiment, the communications of the low-accuracy measurements and the high-accuracy measurements can be exchanged between the respective devices 102, 105, 110, 115. In this example, the low-accuracy device 105 and the display 110 (and/or database/server 115) can cooperatively perform the calculation of the calibration equations. That is, the processing and calculation of the calibration equations can be performed by one or more of the devices individually, or two or more of the devices can cooperatively perform the processing and calculations.

At operation S5, the display 110 is measured by the LAD 105 to obtain low-accuracy (LA) color measurements. These measurements are then adjusted using the calibration equations at operation S6. For example, if the display 110 uses three color elements, a correction/adjustment of the color measurements can be applied to the measurements obtained in operation S5 using the equations 1-3. Similar to the offloading of the calculator of the calibration equations, the adjustment of the LA color measurements can be partially or fully offloaded to one or more external devices (e.g. display 110, server 115, etc.).

At operation S7, the adjusted color measurement values can be provided as an output of the LAD 105, such as being displayed on a display of the low-accuracy device 105, and/or be communicated to the display 110 being measured and/or to one or more other devices (e.g. server/database 115). In an exemplary embodiment, the adjusted color measurement values can be provided to the display 110 being measured and the settings of the display 110 can be automatically adjusted based on the adjusted color measurement values. In this example, the LAD 105 may be configured to control the display 110 to adjust its settings based on the adjusted color measurement values.

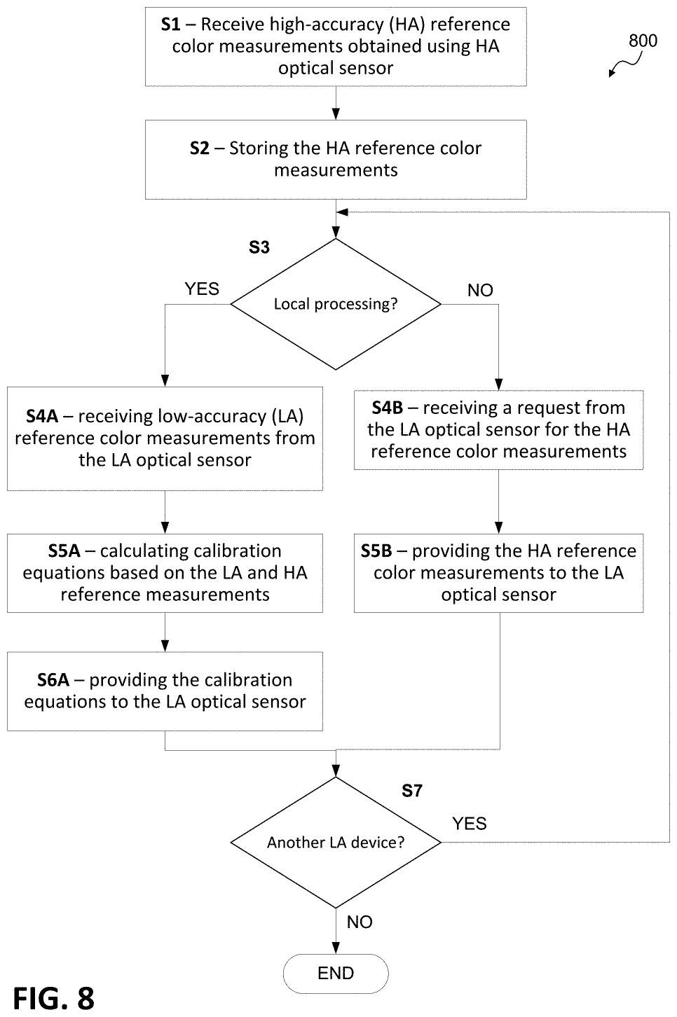

FIG. 8 illustrates a calibration method according to an exemplary embodiment. Two or more of the operations may be performed simultaneously. Further, the operations may be performed in different orders than illustrated. In operation S1, high-accuracy (HA) reference color measurements are received (e.g. by the server 115 or display 110).

At operation S2, the HA reference color measurements are stored in a memory of the device (e.g. memory 460).

At operation S3, it is determined the device (e.g. server 115) will perform the local processing to calculate the calibration equations. If so (YES at operation S3), the device receives the LA reference color measurements (from the LAD 105) at operation S4A. The device then calculates the calibration equations (at S5A) based on the received LA reference color measurements and the HA reference color measurements (from S1). The calibration equations are then provided to the LAD 105 and/or other device to be used in a calibration process for the display 110.

If the calculation of the calibration equations is offloaded (NO at S3), the HA reference color measurements are provided (at S4B) to the LAD 105 and/or other device to be used in a calibration process for the display 110. In one or more embodiments, the LAD 105 can provide a request (at S4B) to the server 115 requesting the HA reference color measurements.

At operation S7, it is determined if another LAD 105 is to be calibrated for the display 110. If so (YES at S7), the flowchart returns to operation S3 where the process is repeated while reusing the HA reference color measurements. If NO at S7, the flowchart ends.

Example Computer System

Various exemplary embodiments described herein can be implemented, for example, using one or more well-known computer systems, such as computer system 900 shown in FIG. 9. Computer system 900 can be any well-known computer capable of performing the functions described herein, such as computers available from Lenovo, Apple, Microsoft, HP, Dell, Sony, Toshiba, etc.

Computer system 900 includes one or more processors (also called central processing units, or CPUs), such as a processor 904. Processor 904 is connected to a communication infrastructure or bus 906.

One or more processors 904 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 900 also includes user input/output device(s) 903, such as monitors, keyboards, pointing devices, etc., which communicate with communication infrastructure 906 through user input/output interface(s) 902.

Computer system 900 also includes a main or primary memory 908, such as random access memory (RAM). Main memory 908 may include one or more levels of cache. Main memory 908 has stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to an exemplary embodiment, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

In an embodiment, a tangible apparatus or article of manufacture comprising a tangible computer useable or readable medium having control logic (software) stored thereon is also referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), causes such data processing devices to operate as described herein.

### Conclusion

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1. A calibration method, comprising:
receiving high-accuracy reference values of reference colors previously obtained from a display using a high-accuracy optical sensor;
determining low-accuracy reference values of the reference colors captured from the display using a low-accuracy optical sensor having a lower accuracy than the high-accuracy optical sensor;
determining color measurement values from one or more colors captured from the display using the low-accuracy optical sensor; and
adjusting the color measurements values, based on one or more color conversion equations, to obtain adjusted color measurement values, wherein the one or more color conversion equations are based on the high-accuracy reference values and the low-accuracy reference values.

2. The method according to claim 1, further comprising repeating, for another low-accuracy optical sensor:
the determining of low-accuracy reference values from reference colors captured from the display;
the determining of color measurement values from one or more colors captured from the display; and
the adjusting of the color measurements values, based on one or more color conversion equations, to obtain adjusted color measurement values,
wherein the high-accuracy reference values are reused for the other low-accuracy optical sensor.

3. The method according to claim 1, further comprising determining the color conversion equations based on the high-accuracy reference values and the determined low-accuracy reference values.

4. The method according to claim 1, wherein the low-accuracy optical sensor is a camera configured to capture Red-Green-Blue (RGB) image data.

5. The method according to claim 1, wherein the low-accuracy optical sensor is colorimeter.

6. The method according to claim 1, wherein the high-accuracy optical sensor is a spectro-radiometer.

7. The method according to claim 1, wherein the high-accuracy optical sensor is a spectro-radiometer and the low-accuracy optical sensor is camera.

8. The method according to claim 1, wherein the received high-accuracy reference values are reusable for a calibration using another low-accuracy optical sensor.

9. A non-transitory computer-readable storage medium with an executable program stored thereon, that when executed, instructs a processor to perform a calibration method comprising:
receiving low-accuracy reference values corresponding to reference colors captured from a display using a low-accuracy optical sensor;
determining color conversion equations based on high-accuracy reference values and the low-accuracy reference values, the high-accuracy reference values having been obtained using a high-accuracy optical sensor having a higher accuracy than the low-accuracy optical sensor; and
transmitting the color conversion equations to the low-accuracy optical sensor, wherein the high-accuracy reference values are reused for one or more subsequent determinations of color conversion equations for the display for one or more other low-accuracy optical sensors.

10. The medium according to claim 9, further comprising, for another low-accuracy optical sensor:
receiving, other low-accuracy reference values corresponding to other reference colors captured from the display using the other low-accuracy optical sensor;
determining other color conversion equations based on the high-accuracy reference values and the other low-accuracy reference values; and
transmitting the other color conversion equations to the other low-accuracy optical sensor.

11. The medium according to claim 9, further comprising receiving the high-accuracy reference values, wherein the high-accuracy reference values correspond to the reference colors having been captured from the display using the high-accuracy optical sensor.

12. The medium according to claim 9, wherein the high-accuracy reference values corresponding to the reference colors captured from the display using the high-accuracy optical sensor.

13. The medium according to claim 9, wherein the low-accuracy optical sensor is a camera configured to capture Red-Green-Blue (RGB) image data.

14. The medium according to claim 9, wherein the low-accuracy optical sensor is colorimeter.

15. The medium according to claim 9, wherein the high-accuracy optical sensor is a spectro-radiometer.

16. The medium according to claim 9, wherein the high-accuracy optical sensor is a spectro-radiometer and the low-accuracy optical sensor is camera.
